(19) United States
(12) Patent Application Publication
(10) Pub. No.: US 2010/0003576 A1
(43) Pub. Date: Jan. 7, 2010

(54) Exhaust apparatus for fuel cell system

(76) Inventor: Kouichi Tamura, Hamamatsu-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/459,620

(22) Filed: Jul. 2, 2009

(30) Foreign Application Priority Data
Jul. 4, 2008 (JP) 2008-175251

(51) Int. Cl. H01M 2/12

(52) U.S. Cl. 429/34

(57) ABSTRACT

An exhaust apparatus for a fuel cell system includes: a fuel cell for receiving air containing oxygen at a cathode and for receiving a fuel gas containing hydrogen at an anode, and for executing a power generation. An exhaust pipe exhausts air from the cathode side and a purge pipe exhausts fuel gas from the anode side. A manifold confluence connects the exhaust pipe and the purge pipe, while a muffler is arranged on a downstream side of the manifold. An upstream side of the exhaust pipe is supported by a vehicle body floor and a downstream side is supported by a subframe. A confluence connecting portion of the purge pipe exhausts used fuel gas containing hydrogen. The exhaust pipe is disposed generally uniformly along a surface that generally is parallel with the ground.

### FIELD OF THE INVENTION

The invention relates to an exhaust apparatus for a fuel cell system. Particularly, the invention relates to a structure technique for emitting a gas component and moisture with respect to a construction in which a gas containing air as an element is emitted, a fuel gas (also referred to as “hydrogen”) is diluted and emitted, or air and gas are mixed.

### BACKGROUND OF THE INVENTION

In a vehicle such as electric vehicle, hybrid vehicle, or the like, a fuel cell (also referred to as “fuel cell stack”) serving as a motive power source is installed.

In the case of supplying pure hydrogen as a fuel gas into the fuel cell, a purgation for temporarily ejecting hydrogen to the outside of the system is executed. The purged hydrogen gas is supplied to an exhaust pipe and the like in which other gases also flow.

An object of the purge is to keep a high conversion efficiency of the fuel cell or to prevent an interpole differential pressure between a cathode and an anode of the fuel cell at the time of vehicle stop or the like from becoming excessive. There is also a case where, if an abnormality occurs in a fuel supplying system, such a gas in an emergency type situation is ejected to the outside of the vehicle.

As for the conversion efficiency of the fuel cell, such a phenomenon that a voltage of the fuel cell drops during the vehicle running, idling stop, or the like occurs.

As one of the causes for such a phenomenon, since the supply gas is humidified or production water is generated by a reaction, their condensation water remains in the fuel cell and a power of the fuel cell decreases. Therefore, a gas flow by a purge is used in order to eject the condensation water to the outside of the system.

As another cause, if the residence or accumulation continues for a long time from circulating hydrogen or the like, a transmission gas of N₂ (nitrogen) from the cathode is liable to be accumulated into the anode system and obstruct the reaction. It is, therefore, necessary to emit the transmission N₂ gas in order to recover.

As for combustion characteristics of hydrogen, when a capacity hydrogen concentration exceeds 4%, hydrogen is liable to combust, and from a point of time when the capacity hydrogen concentration exceeds about 18%, instantaneous and explosive combustion occurs.

Therefore, in the case of using hydrogen for a fuel of a fuel cell, it is required that the maximum capacity hydrogen concentration of the emission gas at the time of ejecting hydrogen from a purge piping is set to 4% or less in consideration of various external environments.

Although moisture is produced by the reaction of the fuel cell, in order to raise a power generation efficiency of the fuel cell by a flowability of ions, the supply gas, that is, the air and hydrogen (also referred to as a “fuel gas”) are humidified. In such a case, not only the production of water generated by the reaction, but also the moisture due to the humidification is contained. Thus a quantity of the moisture in the emission gas increases relatively.

The production water and hydrogen gas emitted into the exhaust pipe in this manner flow into the exhaust pipe together with other gases.

Two prior art references of interest are JP-A-2003-291657 and JP-A-2006-266164.

In the exhaust apparatus of the fuel cell system in the related art, when the production water and hydrogen gas emitted into the exhaust pipe flow in the exhaust pipe together with other gases, steam and water droplets which are contained in the air are exhausted from the fuel cell and are generated at the time of the power generation flow in the exhaust pipe.

If the exhaust pipe has a portion which is curved in the vehicle vertical direction, there is a possibility that the water remains there.

When the vehicle is parked in an environment below-zero, the generated water remains in the curved portion and is frozen. According to circumstances, there is such an inconvenience as the frozen ice blocks the exhaust pipe and when a fuel cell powered vehicle is activated, the air cannot be fed and the vehicle cannot be activated.

When a muffler is necessary in the exhaust pipe, there is a possibility that the water remains on a bottom surface of the muffler.

For example, as disclosed in JP-A-2007-64188, a method of permitting a puddle to a certain extent is considered. In such a case, however, there is such an inconvenience in that weight of parts increases due to the remaining water or, if a scupper or an opening is formed, a quantity of emission gas which is emitted from portions other than the opening edges for exhaustion to the outside increases.

The reasons why the muffler is necessary for the exhaust pipe will be described here. In the fuel cell system, in order to feed the air into the fuel cell so that the power generation is performed at a high efficiency, force feeding means (can also be referred to as a “pump”) is arranged in the air supplying path, thereby pressurizing the air and feeding the pressurized air.

Although the operation for pressurizing and feeding the air increases or decreases to a certain extent in dependence on output control of the fuel cell, waves of condensation and rarefaction of the gas are caused by the force feeding means and such waves are propagated as a sound to a pipeline and are also included in the exhaust gas. It is, therefore, necessary to silence the sound over a band width to a certain extent.

At this time, by selecting a kind of force feeding means, a frequency band or a volume of the sound can be changed and the sound can be made relatively calm.

By constructing so as to silence the sound in such a calm state, even if a function as a muffler is limited and a small muffler is used, an exhaust apparatus which can provide sufficient calmness as a system can be obtained.

At this time, not only can the muffler simply be miniaturized, but also excellent maintainability can be assured owing to an assembly structure according to the simplification of the system.

It is a main object of the invention to provide an exhausting apparatus which takes silencing performance and, further, maintainability into consideration while assuring a function for emitting a gas component and moisture at a high level.

Another object of the invention is to provide an exhaust system (also referred to as an “exhaust pipe”) in which a high space-saving and a high mixing efficiency of emission gas components are obtained, to prevent a backward flow of a gas or production water, and to prevent a specific gas component from flowing into the side of other gas components.

### SUMMARY OF THE INVENTION

To eliminate the foregoing inconveniences, there is provided an exhaust apparatus for a fuel cell system comprising: a fuel cell for supplying air containing oxygen to a cathode, supplying a fuel gas containing hydrogen to an anode, and executing a power generation; a main exhaust pipe which is connected to the cathode side of the fuel cell and exhausts the used air; a purge pipe which is connected to the anode side of the fuel cell and exhausts the used fuel gas; a manifold for confluence-connecting the main exhaust pipe and the purge pipe; and a muffler arranged on a downstream side of the manifold. The exhaust pipe is assembled in such a manner that an upstream side is supported to a vehicle body floor, a downstream side is supported to a subframe, and while including a confluence connecting portion of the purge pipe which serves as the upstream side and exhausts the used fuel gas containing the hydrogen gas, the exhaust pipe is disposed uniformly along a surface that is parallel with a ground within a range from the confluence connecting portion to a downstream side opening serving as the downstream side or the downstream side is lower than the parallel surface.

As described in detail above, according to the invention, there is provided an exhaust apparatus for a fuel cell system comprising: the fuel cell for supplying air containing oxygen to the cathode, supplying the fuel gas containing hydrogen to the anode, and executing the power generation. The main exhaust pipe connects to the cathode side of the fuel cell and exhausts the used air. The purge pipe connects to the anode side of the fuel cell and exhausts the used fuel gas; the manifold confluence connects the main exhaust pipe and the purge pipe; and the muffler is arranged on the downstream side of the manifold, wherein the exhaust pipe is assembled in such a manner that the upstream side is supported to the vehicle body floor, the downstream side is supported to the subframe, and while including the confluence connecting portion of the purge pipe which serves as the upstream side and exhausts the used fuel gas containing the hydrogen gas. The exhaust pipe is disposed uniformly along a surface that is parallel with the ground within a range from the confluence connecting portion to the downstream side opening serving as the downstream side or the downstream side is lower than the parallel surface.

Therefore, within a range from the portion of the exhaust pipe into which the hydrogen gas is introduced to the whole downstream, emitting performance of the hydrogen gas can be improved and the residence or accumulation of a large quantity of hydrogen gas can be prevented.

The draining performance can be improved and the residence or accumulation of the production water can be prevented.

### BRIEF DESCRIPTION OF THE DRAWINGS

FIG. 1 is a schematic left side elevational view of a state where an exhaust-pipe assembly has been mounted in a vehicle for one embodiment of the invention.

FIG. 2 is a schematic left side elevational view of a state where a hydrogen tank assembly has been mounted in the vehicle.

FIG. 3 is a schematic constructional diagram of a fuel cell system.

FIG. 4 is a schematic perspective view of a state where the hydrogen tank assembly is seen from the left rear and downward direction.

FIG. 5 is a schematic perspective view of the exhaust pipe assembly.

FIG. 6A is a front view of a muffler.

FIG. 6B is a cross sectional view of a muffler taken along the line A-A in FIG. 6A.

FIG. 7A is a front view of another embodiment for a muffler.

FIG. 7B is a cross sectional view taken along the line B-B in FIG. 7A.

FIG. 8A is a side elevational view of another second embodiment of the muffler.

FIG. 8B is a cross sectional view taken along the line C-C in FIG. 8A.

### DETAILED DESCRIPTION OF THE INVENTION

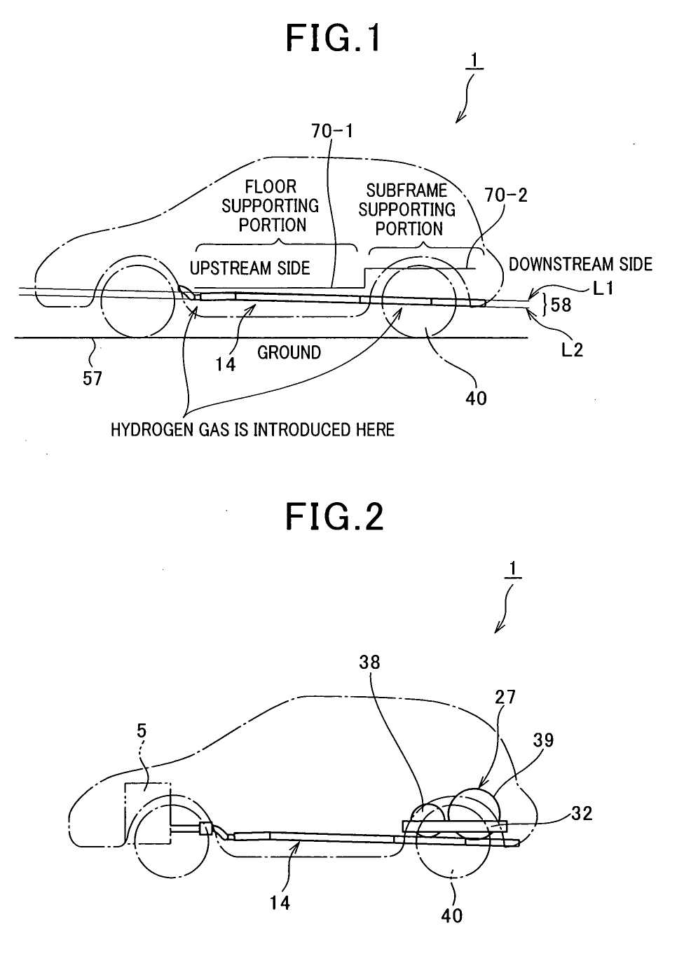

FIGS. 1 to 6B illustrate embodiments of the invention. In FIGS. 1 and 2, a fuel cell powered vehicle (hereinbelow, simply referred to as a “vehicle”) 1 is shown.

A fuel cell system 2 is installed in the vehicle 1. A hydrogen tank assembly (fuel gas tank) 3 is mounted in a rear portion of the vehicle 1. An exhaust system 4 for allowing various kinds of fluids to flow is arranged in a bottom portion of the vehicle 1. Most of the fuel cell system 2 including a fuel cell (stack) 5 is mounted in an enclosing space formed in a front portion of the vehicle 1.

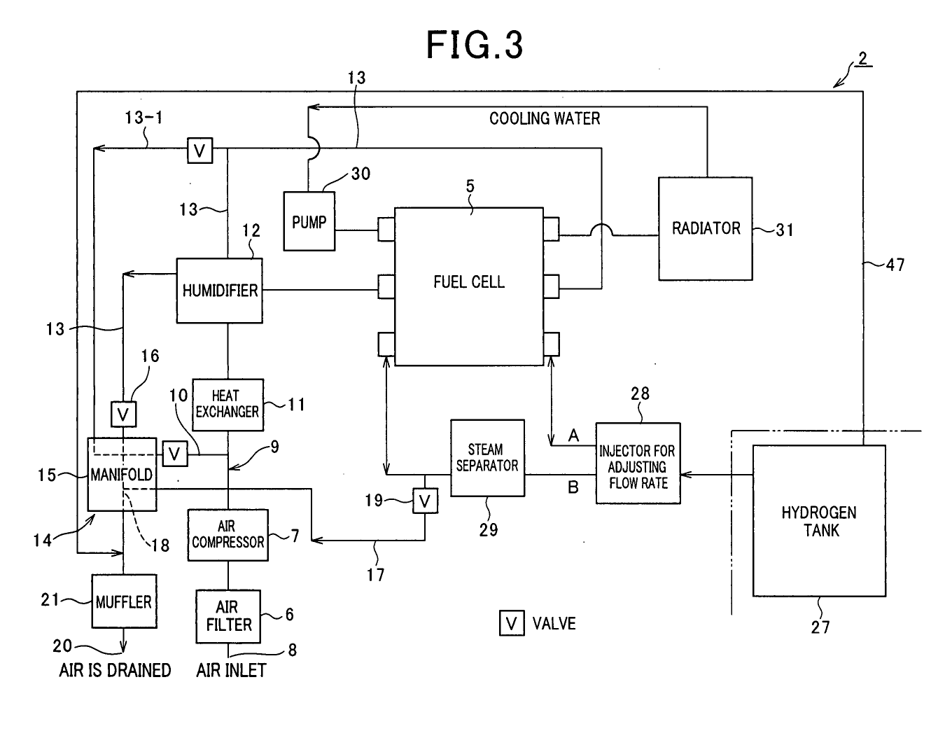

As shown in FIG. 3, a supply emitting system of the air of the fuel cell system 2 is constructed by: a supplying system from an upstream side of the fuel cell 5 to the inside of the fuel cell 5; and an emitting system serving as a downstream side of the fuel cell 5. In the supplying system into the fuel cell 5, the air pulled in from an air inlet 8 by an air compressor 7 (force feeding means) on the downstream side of an air filter 6 is purged by the air filter 6, pressurized by the air compressor 7 to about a few atmospheric pressure, and fed into an intake pipe 9.

At this time, the air compressor 7 has a centrifugal fan such as a turbo compressor and can be driven by an electric motor at a rotational speed of 0 to tens of thousands rpm. Upon driving the air compressor 7, although a pulsation is relatively small, a wind-cutting sound of a high frequency is generated.

Although the air is fed to the cathode side of the fuel cell 5 through the intake pipe 9, a part of the air is exhausted without passing through the fuel cell 5 (by being bypassed by a bypass pipe 10) and a flow rate of the air which flows into the cathode side of the fuel cell 5 is adjusted. The air which is fed to the cathode side of the fuel cell 5 is fed through a heat exchanger 11 and is adjusted to a temperature at which a high power generation efficiency is obtained. After that, the air is humidified by a humidifier 12 so as to obtain a high conversion efficiency by a flowability of ions and is fed to the cathode side of the fuel cell 5. In the fuel cell 5, the air is distributed to a number of cells (not shown) by an internal manifold structure. In some embodiments the fuel cell includes almost an infinite number of cells. After air passes through each cell, the air is emitted to the outside of the fuel cell 5. At this time, each of the intake pipe 9 and the bypass pipe 10 has a relatively large cross sectional area.

In the emitting system serving as a downstream side of the fuel cell 5, the exhaust system 4 is constructed by: a main exhaust pipe 13 just downstream of the fuel cell 5; an exhaust pipe (assembly) 14, which is assembled in dependence on a structure of the vehicle; and the like. In the emitting system, since a moisture (production water and the like) contained in the air (also referred to as an “off-gas”) is used, the air is fed to the humidifier 12. In order to adjust a gas flow rate adapted to adjust an amount of moisture which is used for humidification, a part of the air is emitted without passing through the humidifier 12. An exhaust bypass pipe 13-1 which bypasses the humidifier 12 is a passage having a cross sectional area smaller than that of the main exhaust pipe 13 which passes through the humidifier 12.

Those airs (off-gases) are joined again by a manifold 15 of the exhaust pipe 14 and emitted together with the moisture and the like. By the manifold 15 of the exhaust pipe 14, those airs (off-gases) are also joined with a part of the air which has been branched in the supplying system and is exhausted without passing through the fuel cell 5. A shut-off valve 16 (other valves not labeled) for shutting off a flow of those gases or, contrarily, shutting off a backward flow from the downstream side is provided on an upstream side for each branch pipe of the manifold 15. By a combination of the cross sectional areas of those piping passages having the different cross sectional areas and opening/closing timing of the shut-off valve 16, the flow rate can be adjusted within a range from the flow rate based on only one of the pipings to a control form of constant ratio distribution based on a plurality of pipings.

The gas is also joined with a purge pipe 17 for hydrogen by the manifold 15 of the exhaust pipe 14 and the purge gas is diluted to a thin concentration by the air and emitted. A curved portion 18 is formed on the downstream side from each branch pipe of the manifold 15. The purge pipe 17 for hydrogen having a small cross sectional area is connected to the curved portion 18. A hydrogen purge valve 19 acts as a shut-off valve for shutting off a flow of the purge gas or, contrarily, shutting off a backward flow from the downstream side is also provided on an upstream side of the purge pipe 17. The production water is also contained in the purge gas.

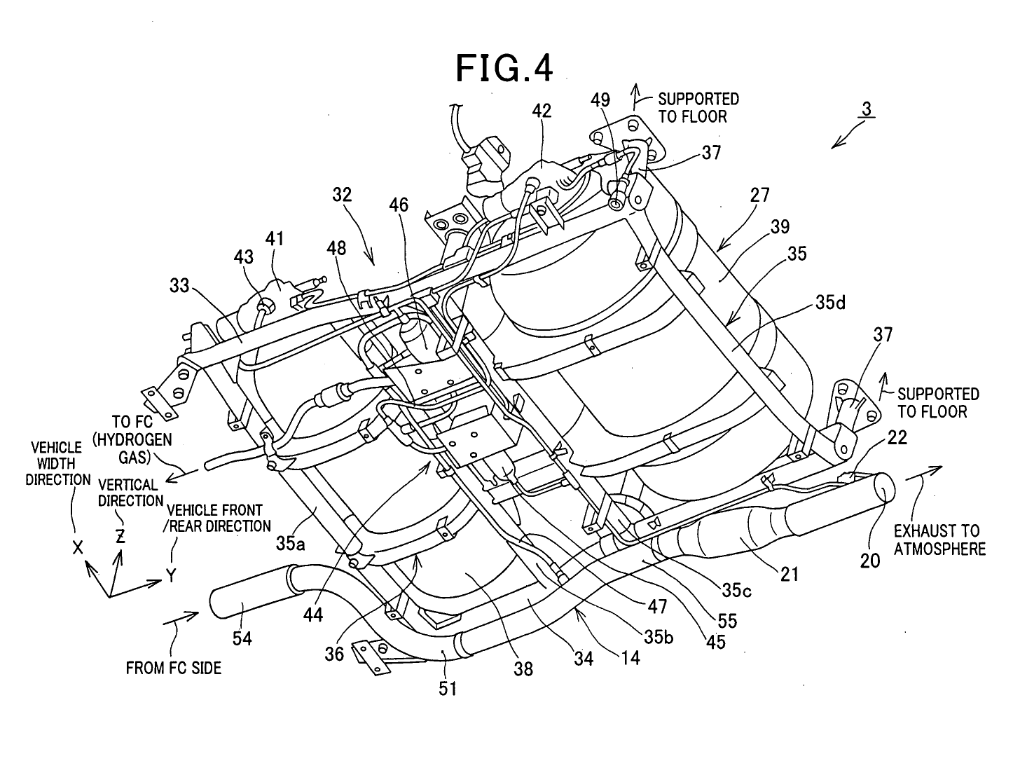

The exhaust pipe 14 is extended toward a vehicle last portion or rear end so as to keep the almost parallel state while wobbling in the vehicle width direction so as to avoid a rectilinear shape and avoid accessories. A sound deadener (also referred to as a “muffler”) 21 is also arranged on a slightly upstream side from a downstream side opening 20 of the exhaust pipe 14. A hydrogen sensor 22 shown in FIG. 4 is provided near the downstream side opening 20 of the exhaust pipe 14, thereby managing a concentration of hydrogen which is emitted so that it is equal to a predetermined value (for example, 4%) or less.

At this time, the muffler 21 is what is called a high frequency pipe and reduces a wind-cutting sound of the air compressor 7, a whistle sound which is caused in a connecting portion or the like of the pipings, or the like. As shown in FIGS. 6A and 6B, the muffler 21 is constructed in such a manner that an outer tube 25 is provided so as to form a cylindrical space around an inner tube 24 having a number of microholes 23, and the cylindrical space is filled with a sound absorbing material 26 made of a glass wool or the like. As tubes for an exhaust pipe of the fuel cell 5, axes of the inner tube 24 and outer tube 25 are set into an offset state, thereby realizing a shape having more excellent draining performance.

Hydrogen is supplied into the fuel cell 5 in the fuel cell system 2, as shown in FIG. 3, in order to raise its using efficiency, by driving a flow rate adjusting injector 28 connected to a fuel tank (also referred to as a “hydrogen tank”) 27. Hydrogen is fed to lines A and B of two systems communicating with one or more outlets/inlets of an anode and one or more outlets/inlets of a cathode of the fuel cell 5 so as to be alternately distributed to lines A and B at a predetermined interval and hydrogen is reciprocatively supplied by using a pressure gradient.

A steam separator 29 connects to one (line B) of the lines of the two systems and the purge pipe 17 for hydrogen is also arranged or connected thereto through the hydrogen purge valve 19. By controlling timing for driving the flow rate adjusting injector 28, timing for driving the hydrogen purge valve 19, and the like, both uniformity of hydrogen concentration and a drain of the production water are satisfied, thereby accomplishing a high efficiency.

A purge for temporarily emitting hydrogen to the outside of the fuel cell system 2 is executed. It is an object of the purge to prevent the interpole differential pressure between the cathode and the anode of the fuel cell 5 from becoming excessive at the time of the vehicle stop or the like in order to keep the high conversion efficiency of the fuel cell 5. There is also a case that when an abnormality has occurred in the fuel supplying system, hydrogen is emergency emitted to the outside of the vehicle.

In the conversion efficiency of the fuel cell 5, such a phenomenon that the cell voltage of the fuel cell 5 drops during vehicle running, idling stop, or the like occurs. One of the reasons for this drop is that, since the supply gas is humidified or the production water is generated by the reaction, their condensation water remains in the fuel cell 5 and a power of the fuel cell 5 decreases. Therefore, a gas flow by the purge is used in order to eject the condensation water to the outside of the system. This also is necessary, because if the circulation is continued, a transmission gas of N₂ from the cathode is liable to be accumulated into the anode system of the fuel cell 5 and obstruct the reaction. It is, therefore, necessary to emit the transmission N₂ gas in order to recover.

The capacity hydrogen concentration of the emission gas at the time of emitting hydrogen from the purge pipe 17 is set to 4% or less.

In the related art, a relatively large capacity is allocated for processes. Near the fuel cell 5 in which its miniaturization is difficult and a large capacity to a certain extent is necessary, several accessories which need a similar large capacity exist. It is very difficult to mount an expensive large apparatus, like a catalyst type into a small vehicle. It is inefficient to prepare a large space for functional parts which are not ordinarily used. The conversion efficiency of the fuel cell 5 can also be set according to the vehicle running on the basis of distribution of a secondary battery and a capacitor and the purge of hydrogen can be changed by its control.

The fuel cell 5 is always held within a temperature range of the high power generation efficiency upon driving by a special coolant which takes a mixture of ions or the like into consideration.

Upon cooling of the fuel cell 5 in the fuel cell system 2, as shown in FIG. 3, a pump 30 is arranged on the inlet side of a cooling water passage of the fuel cell 5 and a radiator 31 is arranged on the outlet side of the cooling water passage of the fuel cell 5. By circulating the cooling water with the pump 30, the temperature of the cooling water is reduced by the radiator 31.

In the hydrogen tank assembly 3 shown in FIG. 4, a subframe (also referred to as “tank frame”) 32 has an almost rectangular outer shape and has: left and right side frames 33 and 34 which form a pair on both sides and extend in the front/rear direction; and a plurality of cross members 35 which couple the left and right side frames 33 and 34. At this time, the cross members 35 are constructed by, for example, four first to fourth cross members 35a, 35b, 35c, and 35d which are arranged in order from the vehicle front side toward the vehicle rear side and each of which extends in the vehicle width direction. A plurality of structure members 36 for coupling middle abdominal portions of the fuel tank 27 extend in the front/rear direction. The fuel tank 27 is strictly fixed by those structure members 36. Two pairs of left and right pedestal portions 37 each for coupling with a vehicle body floor 70 side, particularly, with lower sides of the left and right side frames 33 and 34 are arranged on the subframe 32 in the front/rear direction. Each of the pedestal portions 37 extends upward. After the subframe 32 is mounted to the vehicle, the pedestal portions 37 are strictly coupled therewith.

The fuel tank 27 is constructed in such a manner that two large and small tank cylinders are attached to the subframe 32 so as to be away from each other in the front/rear direction. That is, a first fuel tank 38 as a small tank having a small cross sectional area is arranged on the front side corresponding to a floor 70-1 of a passenger room. A second fuel tank 39 as a large tank having a large cross sectional area is arranged on the rear side corresponding to a floor 70-2 of a luggage compartment. A pair of rear wheels 40 of the vehicle 1 are arranged on both outsides of those tanks so as to overlap partially.

The fuel tank units are equipped with first and second valves 41 and 42 as openings adapted to introduce hydrogen into the first and second fuel tanks 38 and 39 of the fuel tank 27 or to emit hydrogen to the outside of the first and second fuel tanks 38 and 39 of the fuel tank 27, respectively. Independent emergency hydrogen exhaust valves or nozzles, for example, emergency hydrogen exhaust nozzles 43 which are made operative in a state of a higher emergency degree are integratedly provided for the first and second valves 41 and 42, respectively.

The fuel gas which is taken out of the fuel tank 27 is reduced to a desired pressure by a regulator 44 and used. At this time, the fuel gas is divisionally reduced to a plurality of levels by the regulator 44.

The regulator 44 is mounted by using a space formed between the first and second fuel tanks 38 and 39 of the fuel tank 27 so as to be enclosed therein. The first to fourth cross members 35a to 35d of the subframe 32 are arranged in this space, respectively. The regulator 44 is strictly held so as to be built across the first to fourth cross members 35a to 35d.

There are two regulators 44 and the fuel gas is divisionally reduced to multi-levels by them. The high-pressure hydrogen gases taken out of a plurality of first and second fuel tanks 38 and 39 are introduced to a primary regulator 45 attached near the center in the vehicle width direction by a joined piping, are remarkably reduced, and are taken out. Subsequently, the joined or reduced gas is introduced to a secondary regulator 46 arranged on the vehicle side (valve side of the fuel tank unit), is secondarily reduced, is taken out, and is supplied to the fuel cell 5 side. At this time, such a structure in which the regulator 44 which is used in common for a plurality of first and second fuel tanks 38 and 39 exists between them is preferable from a viewpoint of a layout of the pipings.

A hydrogen exhaust pipe 47 for emergency hydrogen emission extends from the secondary regulator 46 and is arranged so as to pass through the space formed between the first and second fuel tanks 38 and 39 in a manner similar to the layout of both of the primary regulator 45 and the secondary regulator 46. The hydrogen exhaust pipe 47 is assembled along a line that is almost parallel with the first to fourth cross members 35a to 35d and the like in the width direction so as to traverse almost the whole width of the subframe 32. The hydrogen exhaust pipe 47 in a range from the regulator 44 to the exhaust pipe 14 is set to be short. A defuel pipe 48, which can emit the hydrogen gas, is provided after the primary regulator 45 and before entering the secondary regulator 46. The hydrogen gas can be taken out of a coupler 49 on the downstream of the second valve 42 by the defuel pipe 48.

A lower edge side of the hydrogen exhaust pipe 47 is connected to the exhaust pipe 14 constructing the fuel cell system 2. It is located in an upper half portion of a cross section of the exhaust pipe 14 and perpendicularly crosses the exhaust pipe 14. An exhaust pipe downstream portion (second pipe) 55 constructing a portion in a range from a slightly upstream side to a downstream edge of the confluence portion is supported to the subframe 32 and can be separated from the vehicle body together with the subframe 32.

The exhaust pipe downstream portion (second pipe) 55 is almost rectilinearly formed along the lower surface of the subframe 32. The muffler 21 is arranged in the exhaust pipe downstream portion 55 serving as a downstream side of the confluence portion. The exhaust pipe downstream portion 55 is supported near the side frame 34 on the vehicle right side as one side of the subframe 32 while including the muffler 21.

According to the laws and regulations, it is necessary to consider a case where it is necessary to take the fuel tank 27 down, for example, it is necessary to exchange the fuel tank 27 every predetermined period, or the like. Since those coupled pipings and the like can be taken down while keeping a coupling state, there is a convenience upon maintenance.

A rear suspension is arranged between an upper surface side of the subframe 32 and the fuel tank 27 and the fuel piping which have been assembled to the subframe 32 and a lower surface of the vehicle body floor 70. Since the rear suspension functions as a link mechanism and works so as to vertically swing, the space is formed in consideration of its locus. The rear suspension is supported to the vehicle body at both of the right and left outside positions of the subframe 32. Since the subframe 32 is not integrated with the suspension frame, when the fuel tank 27 is taken down, there is no need to remove it together with a suspension system including the suspension and the like and high maintainability and ease of repair/replacement is obtained.

Although the fuel tank 27 has a fundamental height depending on its circular cross sectional shape, since an upper surface height of the portion where the regulator 44 is arranged in the space formed between the first and second fuel tanks 38 and 39 is relatively low, a width direction extending member of the rear suspension is arranged there, thereby assuring a stroke of the rear suspension extending in the width direction. It is excellent for ensuring running performance of the vehicle 1. Since the fuel tank 27 as a heavy member can be mounted at a low position, stability of the vehicle position is ensured.

Although not shown, the center portion of the lower surface of the floor 70 within a range from the front side to the rear side is covered with an under cover. Thus, all of the accessories, pipings, and fuel system assemblies such as a pump and the like, which are necessary when constructing the fuel cell system 2, are protected against stepping-stones, submersion, or the like.

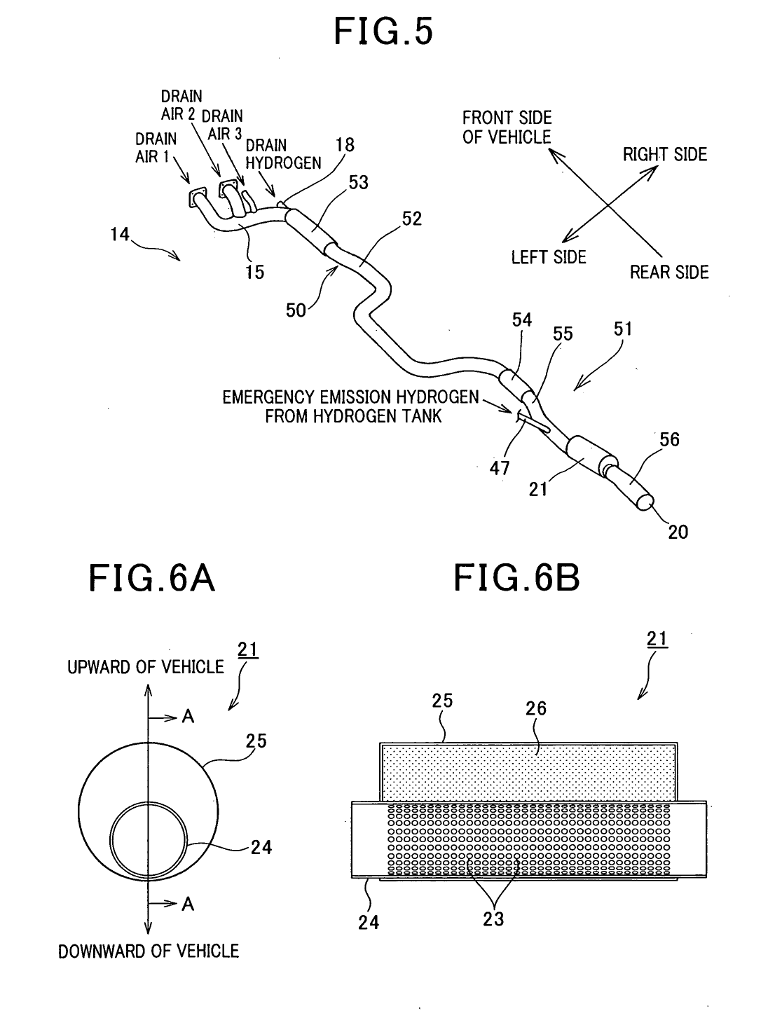

As illustrated in FIG. 5, the exhaust pipe 14 is formed in such a manner that it has the manifold 15 constructing the uppermost-stream side, a front exhaust pipe assembly 50 is constructed on the subsequent upstream side, and a rear exhaust pipe assembly 51 is constructed on the downstream side. The front exhaust pipe assembly 50 is constructed by: a first pipe 52; and a first hose 53 for communicating the downstream side edge portion of the manifold 15 with the upstream side edge portion of the first pipe 52.

The rear exhaust pipe assembly 51 is constructed by: a second hose 54 whose upstream side edge portion communicates with the downstream side edge portion of the first pipe 52; the second pipe 55 communicates with the downstream side edge portion of the second hose 54 and communicates with the upstream side of the muffler 21; and a third pipe 56 communicates with the downstream side of the muffler 21.

The exhaust pipe 14 is assembled in such a manner that the front exhaust pipe assembly 50 (particularly, first pipe 52) serving as an upstream side is supported to the vehicle body floor 70, the rear exhaust pipe assembly 51 (particularly, second pipe 55) serving as a downstream side is supported to the subframe 32. While including the confluence connecting portion (also referred to as a curved portion 18 mentioned above) of the purge pipe 17 which serves as an upstream side and emits the used fuel gas containing the hydrogen gas, the exhaust pipe 14 is assembled uniformly along a parallel surface 58 with the ground 57 within a range from the confluence connecting portion to the downstream side opening 20 serving as its downstream side, or the downstream side is lower than the confluence connecting portion.

In more detail, the exhaust pipe 14 is extended along and provided almost over the whole length of its bottom portion in the vehicle front/rear direction. The upstream side of the exhaust pipe 14 is supported to the vehicle body floor 70 at a plurality of positions (not shown). The downstream side of the exhaust pipe 14 is supported to the subframe 32 at a plurality of positions. At each supporting position, the exhaust pipe 14 is strictly fixed by clamping. The confluence connecting portion of the purge pipe 17 for emitting the used fuel gas containing the hydrogen gas is provided on the upstream side of the supporting position. While including the confluence connecting portion, the exhaust pipe 14 is formed almost in a rectilinear shape within a range from the confluence connecting portion to the downstream side opening 20 serving as its downstream side when seen from the vehicle side surface.

That is, as shown in FIG. 1, when an upper surface line L1 and a lower surface line L2 which are parallel with the ground 57 are set to the vehicle 1, while including the confluence connecting portion of the purge pipe 17 in the exhaust pipe 14, the exhaust pipe 14 is assembled between the upper surface line L1 and the lower surface line L2 so as to be arranged along the parallel surface 58 with the ground 57 into an almost rectilinear shape within a range from the confluence connecting portion to the downstream side opening 20 serving as its downstream side.

Therefore, the exhaust pipe 14 is assembled in a flat shape so as to be uniformly arranged along the parallel surface 58 with the ground 57 or the downstream side is lower than the confluence connecting portion 18.

Thus, within the whole range from the portion of the exhaust pipe 14 where the hydrogen gas is introduced toward the downstream, the emitting performance of the hydrogen gas can be improved and the residence or accumulation of a large quantity of hydrogen gas can be prevented.

The drain performance can be improved and the residence or accumulation of the production water can be prevented.

The fuel supplying system, as well as the fuel tank 27, is fixed to the assembly of the subframe 32.

Since the subframe 32 is provided almost in parallel so that the whole lower surface is parallel with the ground 57, in a rear portion of the subframe 32, a plurality of pairs of right and left pedestal portions 37 for coupling with the vehicle body floor 70 are provided in the front and rear direction.

The subframe 32 is provided at a position which is downwardly away so as to form a space where the exhaust pipe 14 and the like can be enclosed when it is mounted into the vehicle body and is provided by attaching a flat cover (not shown) to a pedestal so as to cover the lower surface of the subframe.

An emergency emitting pipe (since it can also be referred to as a hydrogen exhaust pipe 47 mentioned above, is designated by the same reference numeral and an explanation will be made) 47 for emitting the unused fuel gas containing the hydrogen gas is provided. While including the confluence connecting portion 18 of the purge pipe 17, the emergency emitting pipe 47 is confluence-connected to the exhaust pipe 14 within a range from the confluence connecting portion to the downstream side opening 20. The muffler 21 is arranged on the way of the exhaust pipe 14 serving as a downstream side from the confluence portion.

That is, the emergency emitting pipe 47 is provided so as to be branched from the supplying system of the fuel gas. The emergency emitting pipe 47 emits the unused fuel gas containing the hydrogen gas. Since it is provided for emergency, if some inconvenience occurs, the hydrogen gas is emitted for the purpose of ensuring safety as much as possible. Therefore, when performing the emergency emission, there is a case where the emission of the hydrogen gas is continuously performed until the inconvenience or dangerous quantity is eliminated or removed.

While including the confluence connecting portion 18 of the purge pipe, the emergency emitting pipe 47 is confluence-connected to the exhaust pipe 14 within a range from the confluence connecting portion to the downstream side opening 20. Since the muffler 21 is arranged along the way of the exhaust pipe 14 (second pipe 55) serving as a downstream side for the confluence portion 18, the emergency emitting pipe 47 is confluence-connected from a slightly upstream side position, that is, from the upper surface side of the exhaust pipe 14. The connecting portion forms a boss portion and has such a structure such that the emergency emitting pipe 47 is clamped, fixed, and connected by a union.

At this time, the muffler 21 of a diffusion absorbing type called a high frequency pipe, is provided for the exhaust pipe 14. When a flow speed of the gas flowing in the exhaust pipe 14 rises, an abnormal sound in which a specific frequency has been emphasized is generated by a columnar resonance in each piping which has been confluence-connected to each portion of the exhaust pipe 14. Since, particularly, the high frequency of the abnormal sound is eliminated by the muffler 21 provided on the downstream side of the exhaust pipe 14, silencing performance for the whistle sound which is liable to be generated in the connecting portion of the hydrogen gas piping can be improved. The abnormal sound due to the emergency emitting pipe 47 can be eliminated and suppressed.

According to the silencing effect, the same muffler 21 can be used even for the abnormal sounds of different frequencies and different sound volumes which are generated by a plurality of hydrogen gas pipings.

Further, as shown in FIGS. 6A and 6B, the muffler 21 is formed in such a manner that, with respect to the surface on the side which faces and is close to the ground 57, a space between the inner tube 24 and the outer tube 25 is set to a minimum value or zero. The inner tube 24 having a number of microholes 23 formed so as to have the single diameter is smoothly connected to the exhaust pipe 14 having the same diameter.

Thus, the draining performance in the muffler 21 can be improved and the residence or accumulation of the production water can be prevented without obstructing the gas flow.

The single muffler 21 can minimize a small amount of residual matter remaining in the muffler 21 without being perfectly ejected.

Furthermore, in the exhaust pipe 14, the portion including the confluence connecting portion of the emergency emitting pipe 47 and the muffler 21 is formed as a downstream side portion. This portion is formed separately from the exhaust pipe 14 in the upstream side portion, but instead in the downstream side portion. The exhaust pipe portions of the upstream side portion and the downstream side portion are coupled by the separate flexible hose 53 while keeping hermetic sealing and water-tightness and can be coupled so that they can be divided.

The downstream side portion of the exhaust pipe 14 and the emergency emitting pipe 47 of the hydrogen gas are fixedly supported to the subframe 32. The downstream side portion of the exhaust pipe 14 is assembled along one of the pair of left and right side frames 33 and 34 provided on the left and right sides of the subframe 32 and is fixed at a plurality of positions. The hydrogen exhaust pipe 47 for the hydrogen gas is arranged along the plurality of first to fourth cross members 35a to 35d, which extend in the vehicle width direction of the subframe 32 and are spaced away from each other in the vehicle front/rear direction, and is fixed at a plurality of positions.

The downstream side portion including the hydrogen exhaust pipe 47 and the muffler 21 can be detached from the upstream side portion and can be removed from the vehicle body together with the subframe 32. At this time, since the operation to disconnect the connecting portions of the pipings, such as a connecting portion of the downstream side portion of the exhaust pipe 14 and the hydrogen exhaust pipe 47 and the like does not exist, sealing performance can be held or maintained, and maintenance workability to other parts can also be improved.

The invention is not limited to the foregoing embodiments, but various applications and modifications are possible. For example, in one embodiment of the invention, when the muffler 21 is formed, it is formed in such a manner that with respect to the surface on the side which faces and is close to the ground 57, the space between the inner tube 24 and the outer tube 25 is set to a minimum value or zero. However, in place of the muffler 21 constructed by the circular inner tube 24 and outer tube 25, a muffler 60 having an elliptic outer tube 59 can be also used.

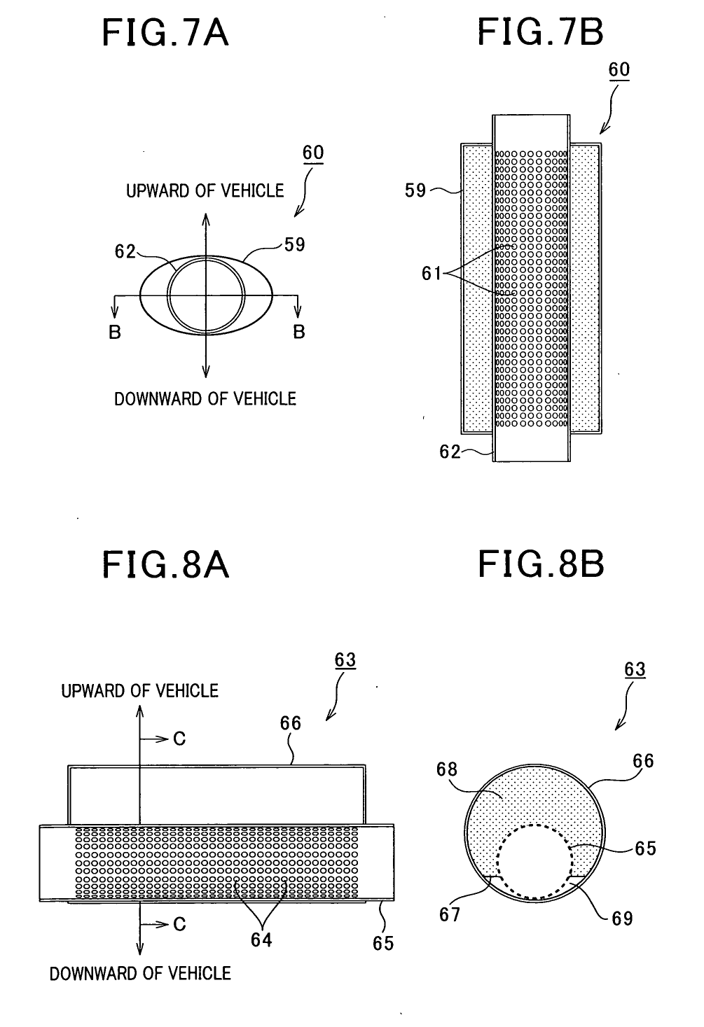

That is, as shown in FIGS. 7A and 7B, the outer tube 59 of the muffler 60 is formed in such a manner that it has an elliptic shape whose major axis is positioned in parallel with the horizontal direction, and at a minor axis locating in the vehicle vertical direction, a space between an inner tube 62 in which an upper surface and a lower surface have a number of microholes 61 and the outer tube 59 is set to a minimum value or zero.

Consequently, in a manner similar to the muffler 21 constructed by the circular inner tube 24 and outer tube 25, the draining performance in the muffler 60 can be improved and the residence or accumulation of the production water can be prevented without obstructing the gas flow.

According to the single muffler 60, a small amount of residual matter, such as liquid, remaining in the muffler 60 without being perfectly drained can be minimized.

FIGS. 8A and 8B show a construction that includes a partition plate 67 attached between an inner tube 65 having a number of microholes 64 and an outer tube 66 of a muffler 63 that also can be used.

That is, when the circular inner tube 65 and outer tube 66 are formed in such a manner that with respect to a surface on the side which faces and is close to the ground, a space between the inner tube 65 and the outer tube 66 is set to a minimum value or zero, as shown in FIGS. 8A and 8B. In an outer peripheral portion, which is slightly away from the side that faces and is close to the ground of the inner tube 65, the partition plate 67 is attached in a horizontal state so as to connect the outer peripheral portion of the inner tube 65 and an inner peripheral portion of the outer tube 66.

Therefore, by attaching the partition plate 67, even if the droplets and steam contained in the air were absorbed into a sound absorbing material 68, the moisture moves downward due to its weight and the water remains in a portion lower than the partition plate 67 (portion where no sound absorbing material 68 exists).

Consequently, since the water moves through the sound absorbing material 68 in a state where it does not absorb the water, the water is capable of being drained by the air flow.

By removing the partition plate 67 and filling a space 69 with a water-repellent steel wool in place of it, the residence or accumulation of the water can be prevented in a manner similar to the partition plate 67 and a sound absorbing effect by the steel wool can be obtained.

A similar effect can be also obtained by a special construction in which a plurality of hole portions (not shown) are formed in the partition plate 67.

1. An exhaust apparatus for a fuel cell system comprising:
a fuel cell for receiving air containing oxygen at a cathode, and for receiving a fuel gas containing hydrogen at an anode, and executing a power generation;
a main exhaust pipe connected to the cathode side of said fuel cell for exhausting the used air;
a purge pipe connected to the anode side of said fuel cell for exhausting the used fuel gas;
a manifold for confluence-connecting said main exhaust pipe and said purge pipe; and
a muffler arranged on a downstream side of said manifold,
wherein an exhaust pipe is assembled with an upstream side supported by a vehicle body floor, a downstream side supported by a subframe, and including a confluence connecting portion of said purge pipe which comprises a part of said upstream side for exhausting the used fuel gas containing the hydrogen gas, wherein the exhaust pipe is disposed essentially uniformly along a surface that is generally parallel with a ground within a range from said confluence connecting portion to a downstream side opening serving as said downstream side or to the downstream side that is lower than said parallel surface.

2. The exhaust apparatus for the fuel cell system according to claim 1, further comprising an emergency exhaust pipe for emergency exhaustion of the unused fuel gas containing the hydrogen gas, wherein said emergency exhaust pipe is confluence-connected to said exhaust pipe within a range from said confluence connecting portion to said downstream side opening, and said muffler is arranged on the downstream side of said exhaust pipe.

3. The exhaust apparatus for the fuel cell system according to claim 1, wherein said muffler is constructed so that with respect to a surface thereof which faces and is close to the ground, a space between an inner tube and an outer tube of the muffler is set to a minimum value or zero and said inner tube is connected to said exhaust pipe.

4. The exhaust apparatus for the fuel cell system according to claim 1, wherein said exhaust pipe is provided so that a downstream side portion including said confluence connecting portion of said emergency exhaust pipe and said muffler is formed divisionally from an upstream side portion, wherein said upstream side portion and said downstream side portion are coupled by a hose so that they can be divided, and said downstream side portion and said emergency exhaust pipe are provided to be supported by said subframe.
